(19) United States
(12) Patent Application Publication
(10) Pub. No.: US 2025/0109519 A1
(43) Pub. Date: Apr. 3, 2025

(54) Determining Distance from Printheads in Electrochemical-Additive Manufacturing Systems

(71) Applicant: Fabric8Labs, Inc., San Diego, CA (US)

(72) Inventors: Justin Pierce, San Diego, CA (US); Joshua Gillespie, Los Angeles, CA (US); Kareemullah Shaik, San Diego, CA (US); David Wong, San Diego, CA (US)

(21) Appl. No.: 18/899,051

(22) Filed: Sep. 27, 2024

Related U.S. Application Data
(60) Provisional application No. 63/586,573, filed on Sep. 29, 2023.

(51) Int. Cl. C25D 21/12; B33Y 50/02; C25D 1/00

(52) U.S. Cl. CPC C25D 21/12; C25D 1/003; B33Y 50/02

(57) ABSTRACT

Described herein are ECAM systems and methods of operating such systems or, more specifically, methods of determining the spacing between build plates and printheads before deposits contact the printheads. A method may comprise positioning a build plate and a printhead (e.g., comprising a copper deposit) at a set orientation relative to each other and for some time (e.g., to allow changes in the electrolyte between the build plate and the printhead and/or changes to the printhead's electrode surface). Thereafter, a measuring voltage is applied between each pixelated electrode of the printhead and a measuring reference plate (which may be the build plate or another plate) while obtaining one or more current values. These current values are then compared to the calibration data set to determine the distances between this electrode and the build plate or, more specifically, the deposit on the build plate.

### CROSS-REFERENCE TO RELATED APPLICATIONS

This application claims the benefit of priority to U.S. Provisional Patent Application Ser. No. 63/586,573 filed on 2023 Sep. 29, and entitled “SOFT SHORTING”, the foregoing incorporated by reference in its entirety.

### BACKGROUND

Additive manufacturing, also known as 3-dimensional (3D) printing, is often used to produce complex parts using a layer-by-layer deposition process on substrates. Additive manufacturing can utilize a variety of processes in which various materials (e.g., plastics, liquids, and/or powders) are deposited, joined, and/or solidified. Some examples of techniques used for additive manufacturing include vat photopolymerization, material jetting, binder jetting, powder bed fusion (e.g., using selective laser melting or electron beam melting), material extrusion, directed energy deposition, and sheet lamination. However, metal additive manufacturing has been limited due to the high cost associated with selective laser melting and electron beam melting systems. Furthermore, thermal fusing produces parts with rough surface finishes because the unmelted metal powder is often sintered to the outer edges of the finished product. Electrochemical-additive manufacturing (ECAM) provides many new options not available with conventional additive manufacturing techniques.

### SUMMARY

Described herein are ECAM systems and methods of operating such systems or, more specifically, methods of determining the spacing between build plates and printheads before deposits contact the printheads. A method may comprise positioning a build plate and a printhead (e.g., comprising a copper deposit) at a set orientation relative to each other and for some time (e.g., to allow changes in the electrolyte between the build plate and the printhead and/or changes to the printhead's electrode surface). Thereafter, a measuring voltage is applied between each pixelated electrode of the printhead and a measuring reference plate (which may be the build plate or another plate) while obtaining one or more current values. These current values are then compared to the calibration data set to determine the distances between this electrode and the build plate or, more specifically, the deposit on the build plate.

Clause 1. A method of operating an ECAM system comprising a build plate and a printhead, the method comprising: positioning the build plate and the printhead at a set orientation for a settling period, wherein: the build plate comprises a first copper deposit facing the printhead, the printhead comprises a set of pixelated electrodes aligned with the first copper deposit, and a space between the set of pixelated electrodes and the first copper deposit is filled with an electrolyte; applying a measuring voltage between a measuring reference plate and the set of pixelated electrodes while obtaining one or more current values of current passing through each pixelated electrode in the set of pixelated electrodes over a measuring time and while a space between the set of pixelated electrodes and the measuring reference plate is filed with a measuring electrolyte; determining one or more distance values forming a contour map and representing a distance between each pixelated electrode in the set of pixelated electrodes and the first copper deposit on the build plate based on the one or more current values obtained for that pixelated electrode; and generating a target map based on the one or more distance values, wherein: the target map is specific to the first copper deposit on the build plate, the target map identifies a first subset of pixelated electrodes in the set of pixelated electrodes to apply a deposition voltage relative to the build plate when depositing a second copper deposit over the first copper deposit such that the second copper deposit is aligned with the first subset of pixelated electrodes, and the target map identifies a second subset of pixelated electrodes in the set of pixelated electrodes not to apply any voltage relative to the build plate when depositing the second copper deposit over the first copper deposit such that the second copper deposit is positioned away from the second subset of pixelated electrodes.

Clause 2. The method of clause 1, wherein: positioning the build plate and the printhead at the set orientation comprises depositing the first copper deposit on the build plate by applying the deposition voltage between the build plate and the set of pixelated electrodes, and the set of pixelated electrodes is identified in an initial target map.

Clause 3. The method of clause 1, further comprising depositing the second copper deposit over the first copper deposit by applying the deposition voltage between the build plate and the first subset of pixelated electrodes.

Clause 4. The method of clause 3, further comprises repeating (a) positioning the build plate and the printhead at the set orientation for the settling period, (b) applying the measuring voltage, (c) determining the one or more distance values, and (d) generating the target map.

Clause 5. The method of clause 1, wherein the measuring reference plate is the build plate.

Clause 6. The method of clause 5, wherein the one or more current values correspond to a concentration of cuprous cations (Cu+) in the measuring electrolyte accumulated proximate to this pixelated electrode in the set of pixelated electrodes while the set orientation is maintained between the build plate and the printhead for the settling period.

Clause 7. The method of clause 5, wherein the electrolyte is used as the measuring electrolyte while applying the measuring voltage.

Clause 8. The method of clause 7, wherein the measuring electrolyte further comprises cupric ions (Cu2+) in addition to cuprous cations (Cu+) generated in the measuring electrolyte while positioning the build plate and the printhead at the set orientation for the settling period.

Clause 9. The method of clause 1, wherein: the measuring reference plate is different from the build plate, and after positioning the build plate and the printhead at the set orientation for the settling period and prior to applying the measuring voltage between the measuring reference plate and the set of pixelated electrodes, the build plate is replaced with the measuring reference plate.

Clause 10. The method of clause 9, wherein each of the one or more current values corresponds to surface modifications of this pixelated electrode in the set of pixelated electrodes while the set orientation is maintained between the build plate and the printhead for the settling period.

Clause 11. The method of clause 10, wherein the surface modifications correspond to a concentration of cuprous cations (Cu+) in the measuring electrolyte accumulated proximate to this pixelated electrode in the set of pixelated electrodes while the set orientation is maintained between the build plate and the printhead for the settling period.

Clause 12. The method of clause 9, wherein, after positioning the build plate and the printhead at the set orientation for the settling period and prior to applying the measuring voltage between the measuring reference plate and the set of pixelated electrodes, the electrolyte is replaced with the measuring electrolyte having a different composition from the electrolyte.

Clause 13. The method of clause 1, further comprising, while positioning the build plate and the printhead at the set orientation for the settling period, applying a deposition voltage between the build plate and an additional set of pixelated electrodes of the printhead thereby depositing an additional first copper deposit aligned with the additional set of pixelated electrodes and away from the first copper deposit.

Clause 14. The method of clause 1, wherein the settling period is between 1 second and 20 seconds.

Clause 15. The method of clause 1, wherein the measuring voltage is between 1V and 6V.

Clause 16. The method of clause 1, wherein the measuring voltage is between 2V and 4V.

Clause 17. The method of clause 1, wherein each of the one or more current values has a corresponding time value representing a duration to achieve this one of one or more current values.

Clause 18. The method of clause 1, wherein determining the one or more distance values is performed using a calibration dataset.

Clause 19. The method of clause 18, wherein the calibration dataset is obtained using the electrolyte having substantially similar temperature, acidity, chloride content, cupric ion (Cu2+) concentrations, and viscosity as the electrolyte used for positioning the build plate and the printhead at the set orientation for the settling period.

Clause 20. The method of clause 1, wherein the ECAM system comprises a system controller that performs (1) determining the one or more distance values and (2) generating the target map.

These and other embodiments are described further below with reference to the figures.

### BRIEF DESCRIPTION OF THE DRAWINGS

FIG. 1A is a schematic illustration of an ECAM system comprising a build plate and a printhead comprising a set of pixelated electrodes as well as electrolyte provided between the build plate and printhead, in accordance with some examples.

FIG. 1B is a schematic planar view of a printhead comprising a set of pixelated electrodes arranged into a two-dimensional array, in accordance with some examples.

FIG. 1C is a schematic cross-sectional view of an ECAM system illustrating the electrolytic deposition of material from the electrolyte onto a build plate by controlling the current through each pixelated electrode, in accordance with some examples.

FIG. 1D is a block diagram illustrating various components of an electrolytic solution used for electrolytic deposition, in accordance with some examples.

FIGS. 2A-2D are schematic illustrations of forming and detecting direct contacts (“hard shorts”) between deposits on a build plate and pixelated electrodes, in accordance with some examples.

FIGS. 3A-3D are schematic illustrations of detecting spacing between deposits on a build plate and pixelated electrodes (“soft shorts”) thereby preventing the forming of direct contacts (“hard shorts”) between such deposits and electrodes, in accordance with some examples.

FIG. 4 is a process flowchart corresponding to a method of operating an ECAM system for detecting spacing between deposits on a build plate and pixelated electrodes, in accordance with some examples.

FIG. 5 is a block diagram illustrating various datasets used in the method of FIG. 4, in accordance with some examples.

FIG. 6A is a schematic illustration of different gaps between copper deposit portions and pixelated electrodes, in accordance with some examples.

FIG. 6B is a plot of the current response to applying a measuring voltage as a function of time for different gaps illustrated in FIG. 6A, in accordance with some examples.

FIG. 7A is a schematic illustration of multiple copper deposit portions and corresponding pixelated electrodes, in accordance with some examples.

FIG. 7B is a time profile for managing the deposition and space detection cycles for different pixelated electrodes shown in FIG. 7A, in accordance with some examples.

### DETAILED DESCRIPTION

In the following description, numerous specific details are outlined to provide a thorough understanding of the presented concepts. The presented concepts may be practiced without some or all of these specific details. In other instances, well-known process operations have not been described in detail to not unnecessarily obscure the described concepts. While some concepts will be described in conjunction with the specific embodiments, it will be understood that these embodiments are not intended to be limiting.

### Introduction

ECAM systems may utilize pixelated electrode arrays, which may be arranged into an ECAM printhead. An electrode array arranged into a printhead can be used (e.g., as a set of independently controlled anodes) for electrochemical material deposition on a build plate (e.g., as a cathode) with ionic-containing electrolyte therebetween. The electrode array can also be used for measurements. During deposition, the distance between the electrode array and material deposit needs to be kept to a minimum to enable more efficient ionic current flow through the electrolyte positioned in the gap between the array or, more specifically, an activated subset of the pixelated electrodes and the material deposits. The ions are carried to, reduced to metal, and deposited on the build plate in the area corresponding to the activated subset of pixelated electrodes. For example, the average distance between the electrode array and the material deposit maybe 30-100 micrometers or, more specifically, 55-65 micrometers. Furthermore, the actual distance may deviate from the average based on the design topography of the material deposit surface, which faces the electrode array. It should be noted that, at least in some examples, the surface of the electrode array facing the deposit is substantially planar.

If the spacing between the material deposit surface and the electrode array is not determined, this surface may come in contact with one or more pixelated electrodes, which can be referred to as a “hard short.” While hard shorts are easy to detect (e.g., by measuring current spikes through the shorted electrodes), hard shorts are not desirable. Specifically, hard shorts may adhere the material deposit surface to the pixelated electrodes preventing further control of the gap between the material deposit surface and electrode array. In other words, the printhead becomes stuck to the deposit and cannot be moved relative to the build plate. Furthermore, when the material deposit is eventually separated from the electrode array, this separation process may damage the electrodes and/or portions of the material deposit that are bonded to these electrodes.

Mapping processes or, more specifically, methods of determining the spacing between build plates and printheads may be used to reduce the risk of hard shorts. These methods are based on detecting changes in the electrolyte (that occur in the gaps between the deposit and pixelated electrodes) either directly (e.g., by applying a measuring voltage to the electrolyte and analyzing the current response) and/or indirectly (e.g., by using a different reference plate and electrolyte and effectively measuring any changes to the pixelated electrodes such as surface modifications caused by the original electrolyte changes). In some examples, a mapping process may be performed (on a subset of pixelated electrodes) concurrently with deposition performed using a different subset of pixelated electrodes.

Such mapping processes may be used periodically, e.g., during a pause in the deposition (“printing”) process. If the deposition cycle proceeds too long between these pauses, hard shorts may be formed. Furthermore, the mapping may be used to make various adjustments to future deposition cycles, e.g., generating a new target map that is used. Some examples of adjustments include, but are not limited to, disabling a subset of electrodes (e.g., that are positioned too close to the deposit), ending deposition layers, and the like. Overall, mapping processes help to ensure accurate deposit growth and prevent damage to the printhead array caused by hard shorts.

It should be noted that the detection of hard shorts may be a part of the mapping process as well. Once hard shorts are detected, the target map disables the shorted electrodes from subsequent voltage applications. As stated above, a hard short occurs when there is no gap/spacing between an electrode and the deposited material surface. For purposes of this disclosure, the term “gap” means at least some space between an electrode and deposited material surface, i.e., the distance greater than zero, such as the space of at least 0.1 micrometers or at least 1 micrometer. When a gap exists between an electrode and deposited material surface, it may be referred to as a “soft short” (to differentiate from “hard shorts” when no gap exists). Soft shorts are much harder to determine than hard shorts since hard shorts have very clear signatures, i.e., current spikes when the hard shorts are formed.

Specifically, to detect soft shorts, corresponding a subset of pixelated electrodes is turned off in some order during the overall deposition process. This turning-off process may be referred to as a “wipe” or “clear” phase. The turning-off order may be the same or different than the turning-on order. For example, different pixelated electrodes may have the same or different deposition cycle durations.

Once the subset of pixelated electrodes is turned off, a wait is performed (e.g., for a settling period). Thereafter, the pixelated electrodes are read in the same (or equivalent) order to create a contour map of the state of all the pixelated electrodes at approximately the same time relative to when they were deactivated. Specifically, based on the time waited (also a function of the environmental parameters such as temperature, electrolyte properties, etc.) and the current response during the “reading” operation, the contour map is generated. A contour map reflects the proximity of each electrode in the subset of tested pixelated electrodes relative to the deposited material surface. As such, a contour map may be also referred to as a deposit topographic map. In some examples, the contour map shows which pixels are at or below a threshold distance instead of just showing the shorted (distance=0) pixels.

It has been found that the current response is representative of the gap between a pixelated electrode and the deposited material surface (for a specific settling period). It has been also found that as the gap decreases, the time to achieve a certain current level also decreases. Without being restricted to any particular theory, it is believed that this correlation is attributed to the generation (at the deposited material surface) and diffusion (to the pixelated electrode) of the cuprous cations (Cu⁺). Other metal systems are believed to behave similarly. Thus, by fixing the time delay (which may be referred to as a settling period) for each pixelated electrode measurement, the contour map can be generated showing which positions of the deposited material surface protrude beyond a certain threshold.

In some examples, the resolution of this method may be affected by the pitch of the electrode array. For example, in an array with a pixel pitch of 25 micrometers, the deposited material surface positioned about 10 micrometers from the electrode surface may primarily affect this electrode, which may have been the primary electrode to cause the deposit of this surface portion. On the other hand, the deposited material surface that is positioned 60 micrometers or more from the electrode surface is likely to affect neighboring pixels.

### ECAM System Examples

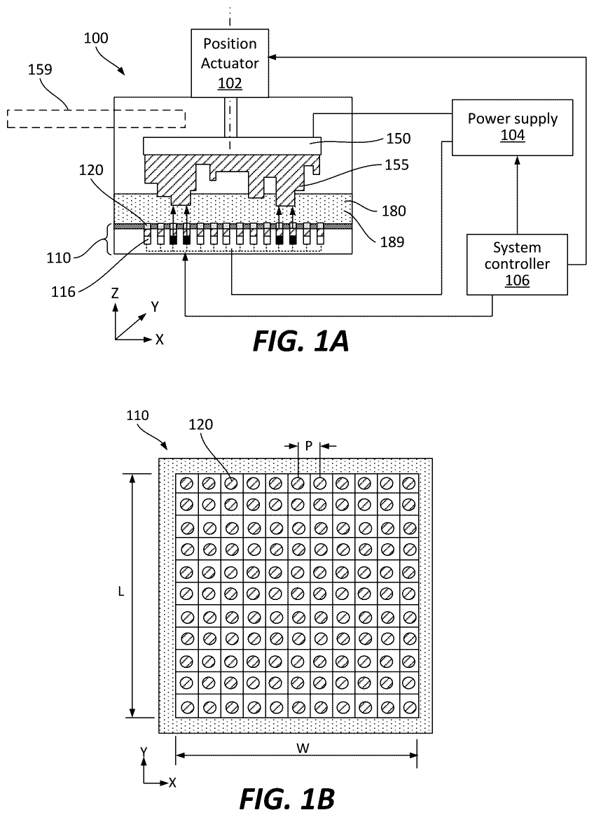

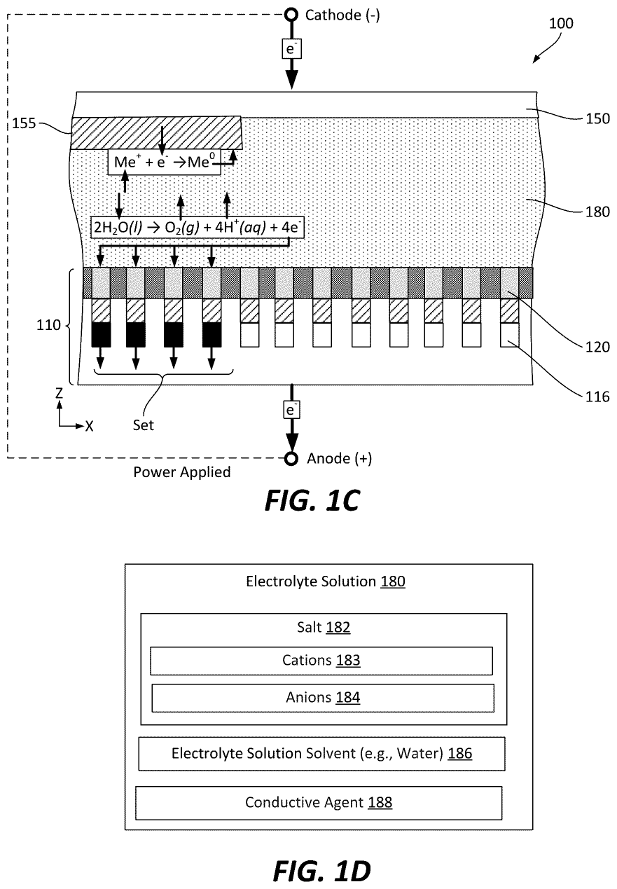

FIG. 1A is a schematic illustration of an ECAM system 100 used for depositing or, more specifically, electroplating material (e.g., copper deposit 155), in accordance with some examples. An ECAM system 100 may comprise a position actuator 102, a system controller 106, a deposition power supply 104, a printhead 110, and a build plate 150. In some examples, a build plate 150 is connected to the deposition power supply 104 and controllably supported relative to the ECAM printhead 110 (e.g., by position actuator 102).

An ECAM printhead 110 or simply a printhead 110 comprises a set of pixelated electrodes 120 and electrode-array drivers 116. Each of the electrode-array drivers 116 controls the current flow through a corresponding electrode in the set of pixelated electrodes 120 as well as the corresponding portion of the electrolyte 180 thereby causing the deposition on the corresponding surface of material (e.g., copper deposit 155) on build plate 150.

A position actuator 102 can be mechanically coupled to the build plate 150 and used to change the relative position of the printhead 110 and build plate 150 (e.g., changing the gap between the printhead 110 and build plate 150 or, more specifically, the gap between the set of pixelated electrodes 120 and build plate 150, linearly moving and/or rotating one or both printhead 110 and build plate 150 within a plane parallel to the set of pixelated electrodes 120). While FIG. 1A illustrates the position actuator 102 that is coupled to the build plate 150, other examples are also within the scope.

A system controller 106 is used for controlling the operations of various components. For example, FIG. 1A illustrates the system controller 106 that is communicatively coupled with the position actuator 102, deposition power supply 104, and electrode-array drivers 116. The system controller 106 can instruct the position actuator 102 to change the relative position of the printhead 110 and build plate 150. In the same or other examples, the system controller 106 can selectively instruct some electrode-array drivers 116 to provide current through corresponding electrodes of the set of pixelated electrodes 120.

During the operation, the ECAM system 100 also comprises electrolyte 180 comprising a source of cations (e.g., metal cations) that are reduced on build plate 150 (operable as a cathode during this operation) and form the material (e.g., copper deposit 155). More specifically, material (e.g., copper deposit 155) is deposited onto build plate 150 from the electrolyte 180 by flowing the electrical current between selected electrodes in the set of pixelated electrodes 120 and the build plate 150 as noted above. In some examples, further granularity is provided by controlling the current levels through each one of the electrode-array drivers 116. In other words, not only the current can be shut off through one or more electrode-array drivers 116 but different levels of current can flow through different electrode-array drivers 116 (and as a result through the corresponding electrodes in the set of pixelated electrodes 120).

Referring to FIG. 1B, a printhead 110 comprises a set of pixelated electrodes 120. These electrodes may be also referred to as microelectrodes (or micro-anodes), and/or pixels. This individually-addressable feature of the set of pixelated electrodes 120 allows the achievement of different deposition rates at different locations on build plate 150. The electrodes form a deposition grid, in which these electrodes may be offset relative to each other along the X-axis and Y-axis, each within a grid footprint. Rectangular grids may be characterized by a grid X-axis pitch (corresponding to the length of each grid region along the X-axis), grid Y-axis pitch (corresponding to the length of a grid region along the Y-axis), overall grid pitch (corresponding to the minimum of the grid X-axis pitch and the grid Y-axis pitch), and grid region area. In the same or other examples, one or both of the grid's X-axis pitch and the Y-axis pitch are 100 micrometers or less, 50 micrometers or less, or even 35 micrometers or less. Other example grids include triangular, hexagonal, or other patterns that partially or completely tessellate a surface. In some examples, the electrodes are formed/deposited from an insoluble conductive material, such as platinum group metals and their associated oxides, doped semiconducting materials, and carbon nanotubes. The shape of the electrodes can be round, rectangular, or other shapes. The area of the electrodes (the pixel size) is smaller (e.g., at least 1% smaller, at least 10% smaller, at least 20% smaller) than the grid footprint, thereby providing space between the electrodes. In some examples, the pitch is between 25 micrometers and 35 micrometers, while the pixel size is between 15 micrometers and 20 micrometers.

FIG. 1C is a schematic expanded view of a portion of ECAM system 100 illustrating electrolyte 180 between the printhead 110 and build plate 150, in accordance with some examples. FIG. 1D is a schematic block diagram illustrating different components of electrolyte 180. For example, electrolyte 180 may comprise salt 182, electrolyte solution solvent 186, and conductive agent 188. Salt comprises cations 183 and anions 184. Cations 183 can be in the form of metal ions, metal complexes, and the like. Some examples of cations 183 include metal cations (e.g., copper ions, nickel ions, tungsten ions, gold ions, silver ions, cobalt ions, chrome ions, iron ions, or tin ions), and other types of cations are within the scope. Some specific examples of salt 182 (feedstock ion sources) include but are not limited to copper sulfate, copper chloride, copper fluoroborate, copper pyrophosphate, nickel sulfate, nickel ammonium sulfate, nickel chloride, nickel fluoroborate, zinc sulfate, sodium thiocyanate, zinc chloride, ammonium chloride, sodium tungstate, cobalt chloride, cobalt sulfate, hydroxy acids, and aqua ammonia. In some examples, feedstock ion sources, or other sources of cations (e.g., salts) are referred to as material concentrates. Electrolyte solution solvent 186 can be water, which dissociates (2H₂O(l)=>O₂(g)+4H⁺(aq.)+4e⁻) on the electrodes that are activated during this operation. Specifically, the activated electrodes are connected to the deposition power supply. In some examples, electrolyte 180 comprises catholyte conductive agent 188, such as an acid (e.g., sulfuric acid, acetic acid, hydrochloric acid, nitric acid, hydrofluoric acid, boric acid, citric acid, and phosphoric acid). In some examples, electrolyte 180 comprises one or more additives, such as a leveler, a suppressor, and an accelerator, particulates for co-deposition (e.g., nanoparticles and microparticles such as diamond particles, tungsten-carbide particles, chromium-carbide particles, and silicon-carbide particles).

Returning to the example shown in FIG. 1D, cations (e.g., metal cations are combined with electrons, which are supplied to build plate 150 thereby forming the material (e.g., copper deposit 155). As noted above, the charge balance within electrolyte 180 is maintained by protons generated at the printhead 110. It should be noted that only a set of activated electrodes (illustrated in black color) can be activated during this ECAM process resulting in electrolytic deposit/material formed on a corresponding portion of build plate 150. This corresponding portion is aligned with the activated electrode while the remaining portion of electrodes (inactive electrodes) remains free of electrolytic deposit. This selective deposition is a core ECAM feature provided by selective control of the current passing through the activated electrodes.

### Examples of ECAM Methods

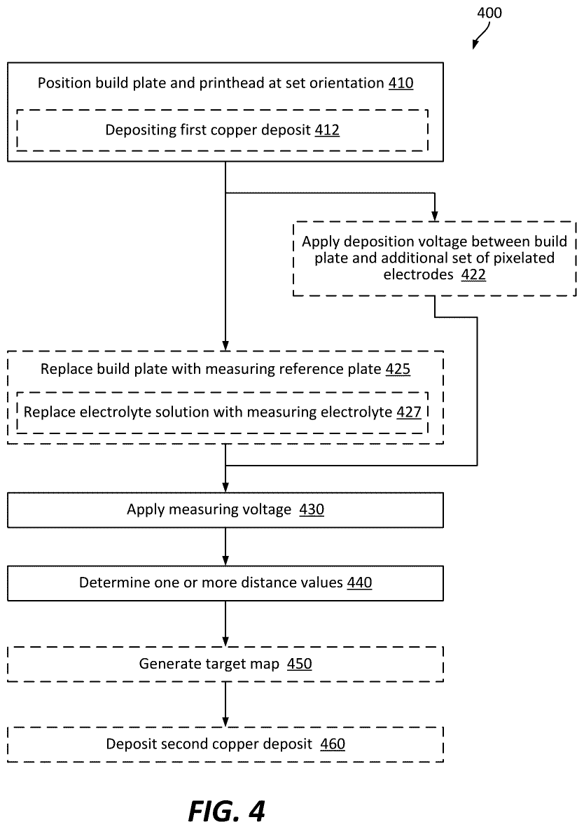

FIG. 4 is a process flowchart corresponding to method 400 of operating an ECAM system 100 comprising a build plate 150 and a printhead 110. Various triggers for method 400 are within the scope and may depend on the composition and/or temperature of the electrolyte 180, current passing through the printhead 110, and other factors. In general, the deposition should proceed as long as possible without causing “hard shorts” or get as close to “hard shorts” as possible without creating “hard shorts”. In some examples, previous experimental data is used to determine this trigger point. In the same or other examples, a Coulomb counter may be used (e.g., a combination of the current density and time) to determine the deposited thickness as a deposition stopping point/trigger point for method 400.

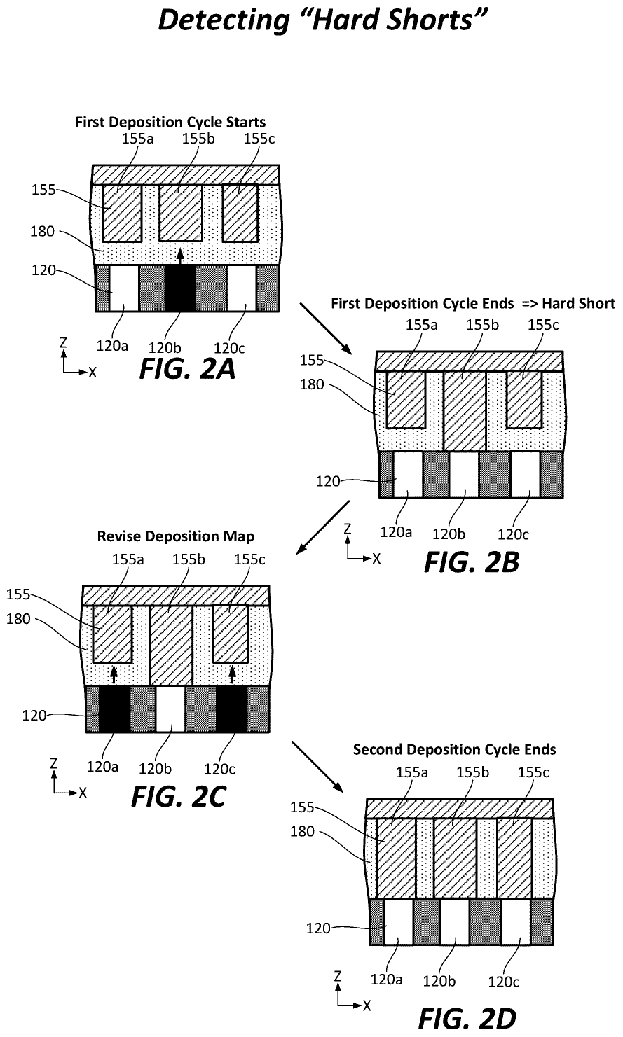

A brief visual comparison of “hard shorts” and “soft shorts” may be helpful in understanding the reasons and triggers for method 400. Specifically, FIGS. 2A-2D are schematic illustrations of forming and detecting direct contacts (“hard shorts”) between deposits on a build plate and pixelated electrodes, in accordance with some examples. In FIG. 2A, only electrode 120b is activated in the set of pixelated electrodes 120. This causes a current to flow between this electrode 120b and a deposit portion 155b. The deposit portions 155a and 155c, which are aligned with electrodes that are not activated do not receive any deposits. It should be noted that deposit portions 155a, 155b, and 155c are shown as discrete structures for visualizations. In reality, these deposit portions 155a, 155b, and 155c may be partially or fully merged. As the ionic current is formed between the deposit portion 155b and electrode 120b, the deposit portion 155b extends closer to electrode 120b until eventually touching electrode 120b, e.g., as shown in FIG. 2B. At this point, the current between the deposit portion 155b and electrode 120b is no longer ionic (through the electrolyte 180) but electronic (through direct contact), which is typically evidenced by the current spike. At this point, the “hard short” is already formed between deposit portion 155b and electrode 120b. The deposit 155 can not be moved away from the set of pixelated electrodes 120. Furthermore, the electrode 120b can no longer be activated. However, other electrodes 120a and 120c can be activated (e.g., as shown in FIG. 2C) to form additional deposits on the deposit portions 155a and 155c (e.g., until these deposit portions also form “hard short” with the electrodes 120a and 120c, e.g., as shown in FIG. 2D).

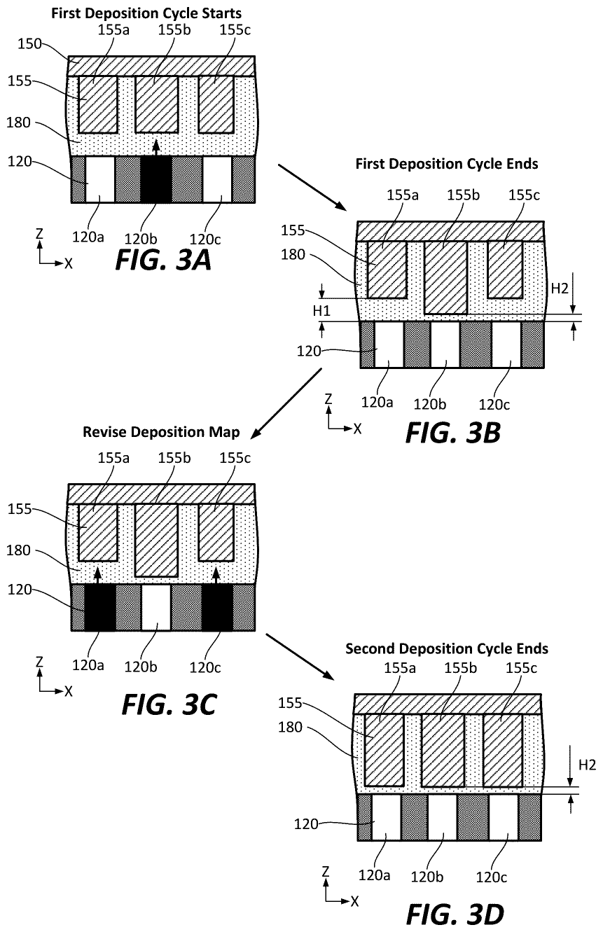

FIGS. 3A-3D are schematic illustrations of detecting spacing between deposits on a build plate 150 and pixelated electrodes (“soft shorts”) thereby preventing the forming of direct contacts (“hard shorts”) between such deposits and electrodes, in accordance with some examples. The initial process in FIG. 3A starts similarly as in FIG. 2A, e.g., the electrode 120b is activated and an additional deposit is formed over the deposit portion 155b. However, before a “hard short” is formed, the electrode 120b is deactivated and a gap (H2) between the electrode 120b and deposit portion 155b can be measured using method 400, e.g., as schematically shown in FIG. 3B. In some examples, the gap (H1) between the previously inactive electrodes 120a and 120c and the corresponding deposit portions 155a and 155c may be measured as well. This gap information (e.g., in the form of a contour map) may be used to control further deposition (e.g., continue with activating the electrode 120b if the gap (H2) is above a threshold by returning to the state shown in FIG. 3A or deactivate the electrode 120b and, instead, activate the electrodes 120a and 120c as shown in FIG. 3C). The activation duration of the electrodes 120a and 120c is also selected such that “hard shorts” are not formed. For example, a gap between these electrodes 120a and 120c and the corresponding deposit portions 155a and 155c may be measured as well, e.g., as shown in FIG. 3D.

Returning to FIG. 4, method 400 comprises (block 410) positioning the build plate 150 and the printhead 110 at a set orientation and maintaining this set orientation for a settling period. For example, this set orientation may be achieved by operating the ECAM system 100 and forming a first copper deposit 155 on the build plate 150. In other words, the deposition may stop while the position of the build plate 150 and the printhead 110 may be maintained. Overall, positioning the build plate 150 and the printhead 110 at the set orientation comprises (block 412) depositing the first copper deposit 155 on the build plate 150 by applying the deposition voltage between the build plate 150 and the set of pixelated electrodes 120. The set of pixelated electrodes 120 is identified in an initial target map (used to form the first copper deposit 155). While this disclosure focuses on copper deposits, other types of deposits (e.g., tungsten, gold) are also within the scope.

Alternatively, the build plate 150 and the printhead 110 may be brought into the set orientation after performing another operation, e.g., providing a new electrolyte into the gap between the first copper deposit 155 and the printhead 110. Without being restricted to any particular theory, it is believed that an electrolyte with a lower concentration of cations may be preferable (e.g., to reduce the noise during the measurement of the cuprous cations (Cu⁺) concentration/improve the baseline). For example, a standard electrolyte may have a substantial concentration of cupric ions (Cu²⁺), which are used to form the copper deposit. As the concentration of cupric ions (Cu²⁺) decreases, the measurement precision of the cuprous cations (Cu⁺) concentration increases. For example, after this gap may be first increased to flow the new electrolyte and then decreased based on the set orientation. This new electrolyte may have a low concentration of cations that the electrolyte previously present in the gap. Alternatively, a used electrolyte (used for the deposition of the first copper deposit 155 and, therefore, having a reduced concentration of cupric ions (Cu²⁺) may be used). The set orientation may correspond to a planned position of the build plate 150 relative to the printhead 110 before starting a new ECAM deposition cycle. This planned position and potentially other parameters of the new ECAM deposition cycle may be changed based on a contour map 541 determined during the execution of method 400.

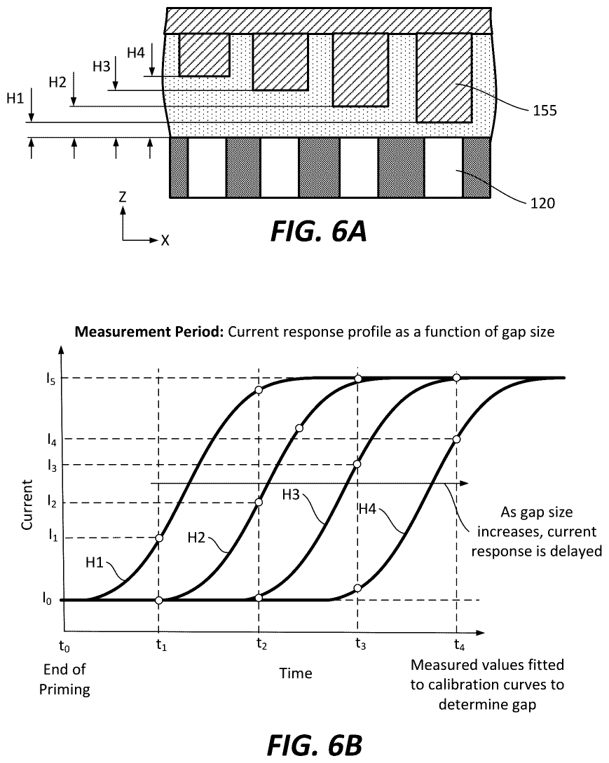

Specifically, when the build plate 150 and the printhead 110 are in at the set orientation, the build plate 150 comprises a first copper deposit 155 facing the printhead 110. Furthermore, the printhead 110 comprises a set of pixelated electrodes 120 aligned with the first copper deposit 155. The space (gap) between the set of pixelated electrodes 120 and the first copper deposit 155 is filled with an electrolyte 180, e.g., as schematically shown in FIG. 6A. In some examples, the space (gap) between the set of pixelated electrodes 120 and the first copper deposit 155 is less than 100 micrometers, less than 60 micrometers or even less than 400 micrometers on average, which enables the gap measurement or, more specifically, to differentiate between different gaps. At larger gap sizes, the ionic generation (at the surface of the first copper deposit 155) and migration (to the surface of the set of pixelated electrodes 120) may take a prohibitively long time. Furthermore, additional factors may interfere with such long measurements.

The set orientation between the build plate 150 and the printhead 110 may be maintained a settling period without applying any voltage between the set of pixelated electrodes 120 and the first copper deposit 155. In some examples, the settling period is between 1 second and 20 seconds or, more specifically, between 5 seconds and 10 seconds. A shorter period is generally desirable to increase the processing throughput (i.e., reduce the time between deposition cycles). However, a period of time is needed for cuprous cations (Cu⁺) to form at the surface of the first copper deposit 155 and migrate to the surface of pixelated electrodes 120.

Without being restricted to any particular theory, it is believed that maintaining this set orientation for the settling period helps to modify the electrolyte composition (in the space between the set of pixelated electrodes 120 and the first copper deposit 155). Specifically, the copper (from the first copper deposit 155) will react with dissolved oxygen in the electrolyte 180 as follows and form copper(II) oxide and copper(I) oxide:

$$2 Cu + {O}_{2} -> 2 CuO Δ G = - 260 kJ / mol \\ 4 Cu + {O}_{2} -> 2 {Cu}_{2} O Δ G = - 300 kJ / mol$$

The copper(II) will react with acid/hydrogen cations (proton/H⁺) as follows and form cuprous cations (Cu⁺):

$$CuO + 2 {H}^{+} -> {Cu}^{+} + {H}^{2} O$$

These cuprous cations (Cu⁺) will diffuse to and accumulate proximate to the set of pixelated electrodes 120. When a measuring voltage is later applied, these cuprous cations (Cu⁺) will react proximate to the surface of pixelated electrodes 120 demonstrating an increased current for short durations (e.g., less than 1 ms)

$${e}^{-} + {Cu}^{+} -> Cu ( at the cathode / build plate 150 ) \\ {Cu}^{+} -> {Cu}^{2 +} + {e}^{-} ( at the anode / pixelated electrodes 120 )$$

As the diffusion of cuprous cations (Cu⁺) takes a significant amount of time (>1 s), the process can be tuned such that the current is measured (while applying a measured current) to determine the gap. Thus, by controlling the rate of diffusion in the electrolyte 180 by controlling the temperature, acidity, chloride content, cupric ion (Cu²⁺) concentrations, viscosity, as well as other characteristics, the repeatability of this measurement may be achieved.

In addition to the settling period, this electrolyte modification further depends on the local distances between the set of pixelated electrodes 120 and the first copper deposit 155 (which may be different for different pixelated electrodes 120, e.g., due to the topography of the first copper deposit 155) as shown in FIGS. 6A and 6B. This electrolyte modification can be later measured to determine these local distances thereby forming a contour map 541. It should be noted that these electrolyte modifications can be measured directly (by maintaining the same (modified) electrolyte between the printhead 110 and the build plate 150) or indirectly (by measuring the effects of this modified electrolyte onto the set of pixelated electrodes 120) as further described below.

In some examples, method 400 comprises (block 425) replacing the build plate 150 with a measuring reference plate 159 that is different from the build plate 150. In general, any type of cathode (e.g., a copper plate, a titanium plate) may be used. This operation is performed after (block 410) positioning the build plate 150 and the printhead 110 at the set orientation for the settling period and prior to (block 430) applying the measuring voltage between the measuring reference plate 159 and the set of pixelated electrodes 120. As part of replacing the build plate 150 with a measuring reference plate 159, the electrolyte 180 may be also replaced with a measuring electrolyte 189 (block 427 being a part of block 425). The measuring electrolyte 189 has a different composition from the electrolyte 180. For example, the measuring electrolyte 189 may be a fresh (unprocessed) version of the electrolyte 180, e.g., the measuring electrolyte 189 may not contain as high a concentration of the cuprous cations (Cut) as the electrolyte 180. In this example, contour map 541 is determined not from the electrolyte characteristics but from the modification of the set of pixelated electrodes 120 caused by the electrolyte 180 while maintaining the set orientation.

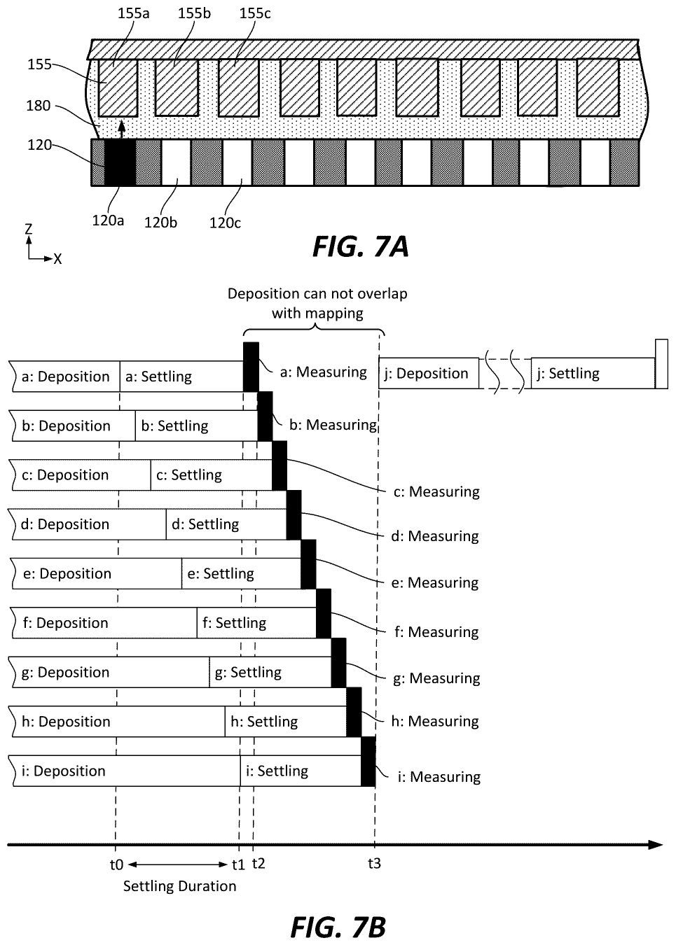

In some examples, method 400 further comprises (block 422) applying a deposition voltage between the build plate 150 and an additional set of pixelated electrodes of the printhead 110. This operation is performed while maintaining the set orientation between the build plate 150 and the printhead 110 for the settling period, thereby enabling parallel processing (i.e., obtaining a contour map 541 for the first subset of pixelated electrodes while forming an additional copper deposit that is aligned with the additional set of pixelated electrodes). Specifically, applying a deposition voltage between the build plate 150 and an additional set of pixelated electrodes of the printhead 110 results in depositing an additional first copper deposit aligned with the additional set of pixelated electrodes and away from the first copper deposit 155. Some aspects of this parallel processing or, more specifically, staggered processing are shown in FIGS. 7A and 7B.

Specifically, FIG. 7A illustrates a processing stage using which deposition is performed between the electrode 120a and deposit portion 155a (with the electrode 120a being activated), while the electrodes 120b and 120c remain inactivated and are within a “settling regime.” FIG. 7B illustrates a sequence for electrodes “a” through “I” going through the “deposition”, “settling”, and “measuring” stages. In some examples (e.g., depending on the configuration of the printhead 110), the “deposition” and “measuring” stages may not overlap.

Method 400 proceeds with (block 430) applying a measuring voltage between a measuring reference plate 159 and the set of pixelated electrodes 120. In some examples, the measuring voltage is between 1V and 6V or, more specifically, between 2V and 4V. It should be noted that higher voltages can lead to unwanted deposition during the measurement and cause less contrast between “un-shorted” and “soft-shorted” electrodes.

The measuring reference plate 159 may be the build plate 150 comprising the first copper deposit 155 or some other plate. Alternatively, the measuring reference plate 159 may be a plate different from the build plate 150 (and does not include any copper deposits) as described above. The measuring voltage is applied while obtaining one or more current values 510 of the current passing through each pixelated electrode in the set of pixelated electrodes 120 and while the space between the set of pixelated electrodes 120 and the measuring reference plate 159 is filed with a measuring electrolyte 189 (which may be the same electrolyte used for maintaining the set orientation between the build plate 150 and the printhead 110 or a different electrolyte).

When the measuring reference plate 159 may be the build plate 150, one or more current values 510 corresponds to a concentration of cuprous cations (Cu⁺) in the measuring electrolyte 189 accumulated proximate to this pixelated electrode in the set of pixelated electrodes 120 while the set orientation is maintained between the build plate 150 and the printhead 110 for the settling period. As such, electrolyte 180 (which has been present between the build plate 150 and the set of pixelated electrodes 120) is used as the measuring electrolyte 189 while applying the measuring voltage. The measuring electrolyte 189 further comprises cupric ions (Cu²⁺) in addition to the cuprous cations (Cu⁺) generated in the measuring electrolyte 189 while maintaining the set orientation between the build plate 150 and the printhead 110 for the settling period.

Alternatively, the measuring reference plate 159 may be different from the build plate 150, e.g., as described above with reference to block 425. This may be referred to as a “raised mapping” process to differentiate from the “direct mapping” process described above. In other words, the build plate 150 is raised from the set of pixelated electrodes 120 prior to this measuring operation and replaced with the measuring reference plate 159 as noted above.

Continuing with this “raised mapping” example and without being restricted to any particular theory, each of the one or more current values 510 may correspond to the surface modifications of this pixelated electrode in the set of pixelated electrodes 120 while the set orientation is maintained between the build plate 150 and the printhead 110 for the settling period.

For example, the surface modifications correspond to a concentration of cuprous cations (Cu⁺) in the measuring electrolyte 189 accumulated proximate to this pixelated electrode in the set of pixelated electrodes 120 while the set orientation is maintained between the build plate 150 and the printhead 110 for the settling period.

Method 400 proceeds with (block 440) determining one or more distance values 540 forming a contour map 541 and representing a distance between each pixelated electrode in the set of pixelated electrodes 120 and the first copper deposit 155 on the build plate 150 based on the one or more current values 510 obtained for that pixelated electrode.

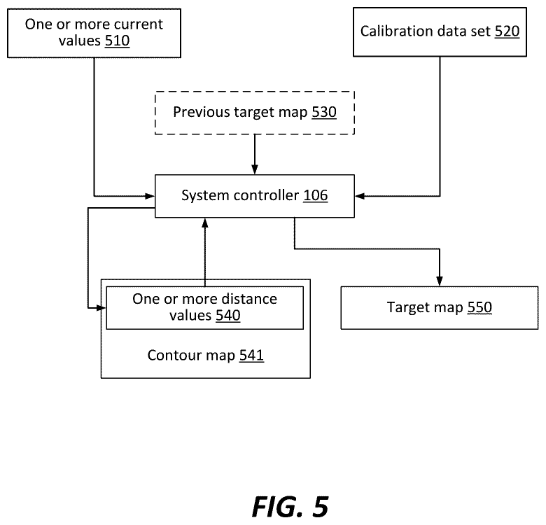

For example, a system controller 106 of the ECAM system 100 may be used. As shown in FIG. 5, a system controller 106 may receive one or more current values 510 and use a calibration dataset 520 to determine the corresponding one or more distance values 540 forming a contour map 541. FIG. 6B is an example of a calibration dataset 520, in the form of a plot of the current response to applying a measuring voltage as a function of time for different gaps illustrated in FIG. 6A, in accordance with some examples. FIG. 6A is a schematic illustration of different gaps between copper deposit portions and pixelated electrodes, in accordance with some examples. As the gap increases, the amount of time takes to achieve a certain current becomes longer. For example, current values may be obtained at predetermined time intervals (e.g., t₁, t₂, t₃, and t₄). Depending on the current values at each time, the gap (e.g., H1, H2, H3, and H4) may be determined.

In some examples, a previous target map 530 is used as well. Furthermore, the contour map 541 may be used to generate a new target map 550 as will now be described.

Method 400 proceeds with (block 450) generating a target map 550 based on one or more distance values 540 or, more generally, based on the contour map 541. The target map 550 is specific to the first copper deposit 155 on the build plate 150 (as well as the set orientation). For example, the target map 550 identifies a first subset of pixelated electrodes in the set of pixelated electrodes 120 to apply a deposition voltage relative to the build plate 150 when depositing a second copper deposit over the first copper deposit 155 such that the second copper deposit is aligned with the first subset of pixelated electrodes. The target map 550 identifies a second subset of pixelated electrodes in the set of pixelated electrodes 120 not to apply any voltage relative to the build plate 150 when depositing the second copper deposit over the first copper deposit 155 such that the second copper deposit is positioned away from the second subset of pixelated electrodes.

In some examples, method 400 further comprises (block 460) depositing the second copper deposit over the first copper deposit 155 by applying the deposition voltage between the build plate 150 and the first subset of pixelated electrodes. In other words, the second copper deposit is deposited in accordance with the target map 550.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered illustrative and not restrictive.

1. A method of operating an ECAM system comprising a build plate and a printhead, the method comprising:
positioning the build plate and the printhead at a set orientation for a settling period, wherein:
the build plate comprises a first copper deposit facing the printhead,
the printhead comprises a set of pixelated electrodes aligned with the first copper deposit, and
a space between the set of pixelated electrodes and the first copper deposit is filled with an electrolyte;
applying a measuring voltage between a measuring reference plate and the set of pixelated electrodes while obtaining one or more current values of current passing through each pixelated electrode in the set of pixelated electrodes over a measuring time and while a space between the set of pixelated electrodes and the measuring reference plate is filed with a measuring electrolyte;
determining one or more distance values forming a contour map and representing a distance between each pixelated electrode in the set of pixelated electrodes and the first copper deposit on the build plate based on the one or more current values obtained for that pixelated electrode; and
generating a target map based on the one or more distance values, wherein:
the target map is specific to the first copper deposit on the build plate,
the target map identifies a first subset of pixelated electrodes in the set of pixelated electrodes to apply a deposition voltage relative to the build plate when depositing a second copper deposit over the first copper deposit such that the second copper deposit is aligned with the first subset of pixelated electrodes, and
the target map identifies a second subset of pixelated electrodes in the set of pixelated electrodes not to apply any voltage relative to the build plate when depositing the second copper deposit over the first copper deposit such that the second copper deposit is positioned away from the second subset of pixelated electrodes.

2. The method of claim 1, wherein:
positioning the build plate and the printhead at the set orientation comprises depositing the first copper deposit on the build plate by applying the deposition voltage between the build plate and the set of pixelated electrodes, and
the set of pixelated electrodes is identified in an initial target map.

3. The method of claim 1, further comprising depositing the second copper deposit over the first copper deposit by applying the deposition voltage between the build plate and the first subset of pixelated electrodes.

4. The method of claim 3, further comprises repeating (a) positioning the build plate and the printhead at the set orientation for the settling period, (b) applying the measuring voltage, (c) determining the one or more distance values, and (d) generating the target map.

5. The method of claim 1, wherein the measuring reference plate is the build plate.

6. The method of claim 5, wherein the one or more current values correspond to a concentration of cuprous cations (Cu⁺) in the measuring electrolyte accumulated proximate to this pixelated electrode in the set of pixelated electrodes while the set orientation is maintained between the build plate and the printhead for the settling period.

7. The method of claim 5, wherein the electrolyte is used as the measuring electrolyte while applying the measuring voltage.

8. The method of claim 7, wherein the measuring electrolyte further comprises cupric ions (Cu²⁺) in addition to cuprous cations (Cu⁺) generated in the measuring electrolyte while positioning the build plate and the printhead at the set orientation for the settling period.

9. The method of claim 1, wherein:
the measuring reference plate is different from the build plate, and
after positioning the build plate and the printhead at the set orientation for the settling period and prior to applying the measuring voltage between the measuring reference plate and the set of pixelated electrodes, the build plate is replaced with the measuring reference plate.

10. The method of claim 9, wherein each of the one or more current values corresponds to surface modifications of this pixelated electrode in the set of pixelated electrodes while the set orientation is maintained between the build plate and the printhead for the settling period.

11. The method of claim 10, wherein the surface modifications correspond to a concentration of cuprous cations (Cu⁺) in the measuring electrolyte accumulated proximate to this pixelated electrode in the set of pixelated electrodes while the set orientation is maintained between the build plate and the printhead for the settling period.

12. The method of claim 9, wherein, after positioning the build plate and the printhead at the set orientation for the settling period and prior to applying the measuring voltage between the measuring reference plate and the set of pixelated electrodes, the electrolyte is replaced with the measuring electrolyte having a different composition from the electrolyte.

13. The method of claim 1, further comprising, while positioning the build plate and the printhead at the set orientation for the settling period, applying a deposition voltage between the build plate and an additional set of pixelated electrodes of the printhead thereby depositing an additional first copper deposit aligned with the additional set of pixelated electrodes and away from the first copper deposit.

14. The method of claim 1, wherein the settling period is between 1 second and 20 seconds.

15. The method of claim 1, wherein the measuring voltage is between 1V and 6V.

16. The method of claim 1, wherein the measuring voltage is between 2V and 4V.

17. The method of claim 1, wherein each of the one or more current values has a corresponding time value representing a duration to achieve this one of one or more current values.

18. The method of claim 1, wherein determining the one or more distance values is performed using a calibration dataset.

19. The method of claim 18, wherein the calibration dataset is obtained using the electrolyte having substantially similar temperature, acidity, chloride content, cupric ion (Cu²⁺) concentrations, and viscosity as the electrolyte used for positioning the build plate and the printhead at the set orientation for the settling period.

20. The method of claim 1, wherein the ECAM system comprises a system controller that performs (1) determining the one or more distance values and (2) generating the target map.
